(19) United States
(12) Patent Application Publication
(10) Pub. No.: US 2018/0288031 A1
(43) Pub. Date: Oct. 4, 2018

(54) COLLECTION POINT ANCHORED MULTI-PROPERTY IDENTITY BASED APPLICATION SPECIFIC TOKEN ORIGINATION

(71) Applicant: CA, Inc., New York, NY (US)

(72) Inventor: Nikhil Kumar, New York, NY (US)

(21) Appl. No.: 15/475,504

(22) Filed: Mar. 31, 2017

(51) Int. Cl. H04L 29/06; H04L 9/08

(52) U.S. Cl. CPC H04L 63/0807; H04L 63/061; H04L 9/0891; H04L 63/0861; H04L 63/0442

(57) ABSTRACT

A secure identity framework has been designed that leverages a host device as a data collection point for four properties of a digital identity profile anchored to the collection point device, and uses the digital identity profile for multi-factor authentication. A public key infrastructure key exchange is conducted for secure identity framework members corresponding to collection and access of data of the digital identity profile. Subsequently, each application participating in the secure identity framework (“participant application”) acts as a certifying authority in additional, distinct PKI key exchanges. Based on the key exchanges, the secure identity framework locally generates application specific token sets based on the digital identity profile for authentication and authorization. The secure identity framework secures exchange of data among hardware and software components of the device with secured application programming interfaces (APIs). Participating applications then use the generated tokens for downstream authentication and authorization.

### BACKGROUND

The disclosure generally relates to the field of information security, and more particularly to authorization and authentication.

User stores play an integral role when it comes to authentication and authorization of users by computer systems, computer applications, service providers and consumer electronic devices. A “user store” typically is a database that stores the information about a user and, in certain instances, roles that are associated with the user. The user store will also persist the information about a user such as First Name, Last Name, address, login identifier, user identifier, password, and e-mail address. This information may also include sensitive information that can uniquely identify a person and can be used for either direct or indirect malicious intent. Some examples of such sensitive user information include Passport Number, Social Security Number (SSN), Tax Identifier Number (TIN), Medical Record Number (MRN), Credit Card Number, and Bank Account Number. The underlying implementation of a user store is generally based on either a commercially available software application or an open source software application instance of either a Database Management System (DBMS) or a Directory Service. Given the amount of information stored in user stores used by organizations (e.g., corporations, institutions, etc.), parties with malicious intent target the user stores of these various organizations. Security data breaches often involve some kind of user information theft from a user store.

### BRIEF DESCRIPTION OF THE DRAWINGS

Embodiments of the disclosure may be better understood by referencing the accompanying drawings.

FIG. 1 depicts an example device configured for self-sufficient, secure identity management.

FIG. 2 depicts a token generator generating the various tokens for an application on a device with the secure identity framework.

FIG. 3 is a flowchart of example operations for creating a digital identity profile using a host device as a collection point.

FIG. 4 is a flowchart of example operations for generating an application specific token set based on a digital identity profile (DIP) within a secure identity framework of a host device.

FIG. 5 is a flowchart of example operations for retrieving and/or generating a token set for an application.

FIG. 6 is a flowchart of example operations to retrieve and/or generate privacy and access tokens for an application.

FIG. 7 is a flowchart of example operations for associating a social media entity with a digital identity profile.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

Overview

Conventional security mechanisms suffer from multiple issues that provide opportunities for security breaches and/or are vulnerable to security breaches. With the myriad of devices and web based applications, users tend to use a same username/password combination across numerous accounts. When a security breach occurs and username/password combinations are stolen from a user store(s) of a single application/service provider, the other accounts at other providers become vulnerable. In addition, transmission of authorization and authentication information is susceptible to man in the middle (MITM) attacks. Furthermore, advanced security procedures and mechanisms can be penetrated with simple phishing attacks. These user stores will continue to be prime targets for malicious attacks because of the potential award of thousands or millions of users' data.

A secure identity framework has been designed that eschews the conventional security mechanisms susceptible to phishing, MITM, and other attacks. This secure identity framework allows access to services without exposing sensitive, identifying information. This secure identity framework leverages a host device as a data collection point for four properties of a digital identity profile anchored to the collection point device, and uses the digital identity profile for multi-factor authentication. A closed public key infrastructure (PKI) key exchange is conducted for the host device and the secure identity framework members corresponding to collection and access of data of the digital identity profile. Subsequently, each application participating in the secure identity framework (“participant application”) acts as a certifying authority in additional, distinct closed PKI key exchanges. Based on the key exchanges, the secure identity framework locally generates application specific token sets based on the digital identity profile for authentication and authorization. The secure identity framework secures exchange of data among hardware and software components of the device with secured application programming interfaces (APIs). Participating applications then use the generated tokens for downstream authentication and authorization.

The digital identity profile (“DIP”) properties include USER IS, USER HAS, USER IS AT, and USER KNOWS. The USER IS property of a DIP indicates that the DIP uniquely identifies a person or user. The USER HAS property indicates that the user has a device. The USER IS AT property establishes a location of the user at a particular time. The USER KNOWS property indicates that a user has knowledge of something. Each application session or transaction bound to at least the three properties of USER IS, USER HAS, and USER IS AT. Thus, each application session is bound to a user, the device of the user, and a location of the device at the time of the session/transaction. Incorporation of the USER KNOWS property further increases the authentication strength.

Example Illustrations

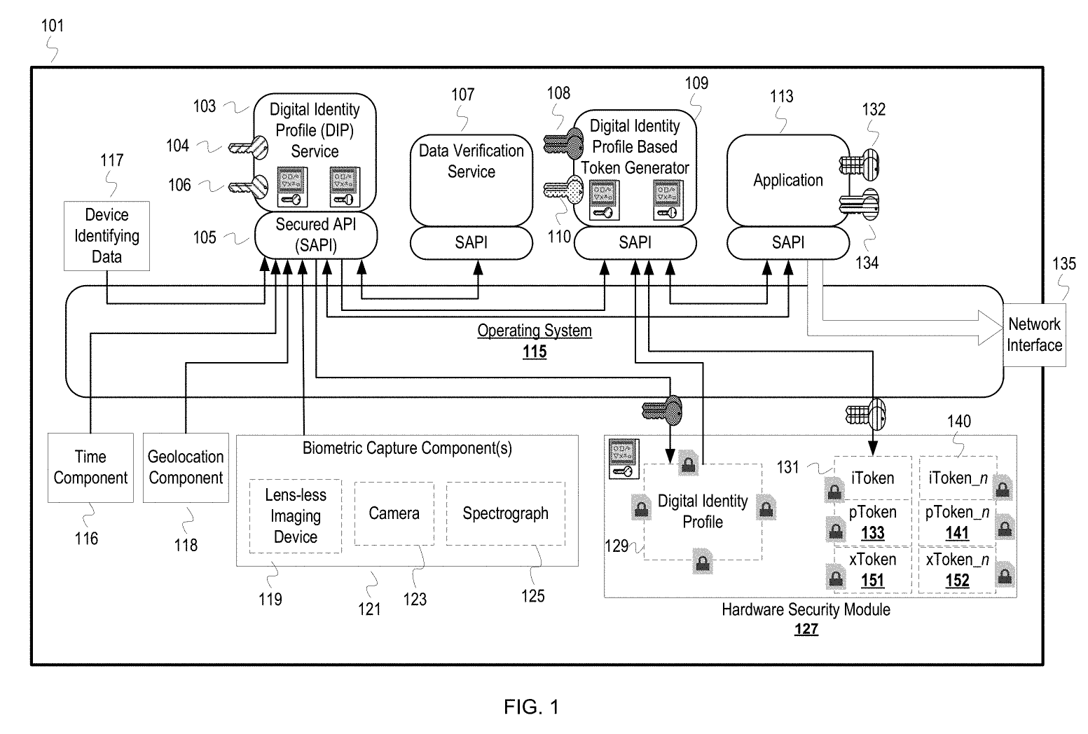

FIG. 1 depicts an example device configured for self-sufficient, secure identity management. FIG. 1 illustrates both hardware and software components of a device 101 that interact through an operating system 115 (e.g., invocation of drivers). The software components include a digital identity profile service (“DIPS”) 103, a data verification service 107, a digital identity profile based token generator 109, and a hardware security module (“HSM”) 127. The DIPS 103 is a service that collects data for a digital identity profile of a user of the device 101, governs access to the digital identity profile, and acts as certifying authority (CA) for a PKI key exchange with the data verification service 107, the digital identity based token generator (hereinafter “token generator”) 109, and the HSM 127. The token generator 109 generates tokens for participant applications based on the digital identity profile. The HSM 127 is an embedded security device/component that generates and manages keys as requested by the DIPS 103, the token generator 109, participant applications, and the data verification service 107. The HSM 127 also securely stores a digital identity profile and tokens generated by the token generator 109. The data verification service 107 is a service that presents knowledge based challenges for authentication (e.g., Completely Automated Public Turing test to tell Computers and Humans Apart (CAPTCHA) program or reCAPTCHA, user specific institutional knowledge (e.g., a financial transaction), etc.). Embodiments can use a third party data verification service. In that case, the data verification service 107 can operate as a participant application in the secure identity framework. Embodiments can use out of band code validation for further authentication (e.g., sending a code via text message or e-mail). These components of the secure identity framework communicate through secure application programming interfaces (“SAPIs”). A SAPI can be implemented in different ways to ensure security. For instance, calling functions via a SAPI may involve the invoking or calling process to digitally sign a request (i.e., an invocation or call). Implementing a SAPI may be ensuring a call or invocation conforms to strict conditions on arguments of the invocation (e.g., limited data types, matches allowed values or falls within a range of allowed values, etc.). Implementations can also do both—require signing of invocations and ensure the invocation is formed properly.

Initially, the DIPS 103 acts as a certifying authority and establishes a closed PKI key exchange with the other secure identity framework components. The DIPS 103 self-certifies and certifies the other secure identity framework components. For instance, the DIPS 103 generates a digital certificate for the token generator 109 with a private key 106 of the DIPS 103 and one of the public keys 108 of the token generator 109. The DIPS 103 provides a public key 104 to components of the secure identity framework for digital certificate validation. After the key exchange, the DIPS 103 can collect data for the digital identity profile of a user. The DIPS 103 collects data for the four properties USER IS, USER HAS, USER IS AT, and USER KNOWS. For the USER IS property, the DIPS 103 collects biometric elements and identifying data, such as non-sensitive identifying data that will likely be commonly used across applications/services and sensitive identifying data. The DIPS 103 uses biometric capture components 121 to collect the biometric elements. In this illustration, the biometric capture components 121 include a lens-less imaging device (LID) 119, a camera 123, and a spectrograph 125. With these biometric capture components 121, the DIPS 103 collects multiple biometric elements that together can be used to authenticate a user. One or more fingerprints and a deoxyribonucleic acid (DNA) profile may be sufficient for frequent authentication, but additional biometric elements form the USER IS property and can be used for less frequent and/or more substantial authentication in addition to other elements of the USER IS property. Examples of the additional biometric elements include retinal scan, iris scan, and facial imagery. The DIPS 103 can use the LID 119 to capture fingerprints and DNA with a same scan, which binds the DNA to another biometric element. In some cases, the LID 119 may not be embedded within the device 101 but coupled to the device 101. The DIPS 103 also collects image data for the USER IS property of the digital identity profile. The DIPS 103 can use the spectrograph 125 and digital camera 123 to capture facial imagery (e.g., an image or video of a user's face) and ocular identification data. The DIPS 103 can use this collected appearance element of the USER IS property for facial recognition profiling, a retinal scan, and/or and an iris scan. The biometric capture components 121 include the capability to detect aqueous humor flow and retinal vessel flow. To facilitate this capability, the host device 101 couples the camera with a light source safe for the retinal and iris scanning. After collecting this biometric information, the DIPS 103 collects identifying information to associate with the biometric elements of USER IS—First Name, Last Name, Address, e-mail address, date of birth, taxpayer identifier, etc.

After the DIPS 103 collects the data for the USER IS property, the DIPS 103 collects the data for the USER HAS property, which anchors the digital identity profile to the device 101. The DIPS 103 obtains device identifying data 117, which can be any one or more of a myriad of identifiers and/or characteristics of the device 101 (e.g., computer system, handheld device wearable, etc.). This can be a background determination after collection of the biometric elements or in tandem with the collection of the biometric elements, or can be based on a user prompt (e.g., prompt asking whether the user trusts the device). Examples of the device identifying data 117 include a device identifier (e.g., serial number), machine fingerprint (“MFP”), Grouped Internet Protocol address (GIP), machine effective speed counter (“MESC”), and hypertext transfer protocol (HTTP) header information. The device identifying data 117 is not limited to a single device. The device identifying data 117 can include data that identifies multiple associated devices, such as paired devices.

For the USER IS AT property of the digital identity profile, the DIPS 103 obtains information from a geolocation component 118. The DIPS 103 can collect longitude, latitude and altitude of where the person bearing the device 101 is located. The DIPS 103 collects time data from a time component 116 and/or a network time service to determine a time when the device and user are at the determined location. The DIPS 103 can also obtain temperature and pressure at the location at the determined time using a web service call to weather service provider. The time information corresponds to creation of the DIP and is later used in generating keys for token encryption.

For the USER KNOWS something property, the DIPS 103 can interact with the data verification service 107 for Knowledge Based Authentication (KBA). A KBA can be performed either locally with the data verification service 107 by presenting (CAPTCHA)/reCAPTCHA or by presenting a challenge for information that presumably only the user has prior knowledge about. An example of such a challenge can be a question about user's financial information associated with a transaction done against the financial institution. Embodiments can use out of band code validation for further authentication (e.g., sending a code via text message or e-mail).

After collecting the information for the digital identity profile, the DIPS 103 encrypts the elements of each property with a different secret of the DIPS 103 and a different public key of the token generator 109, which yields 2 different versions of the encrypted digital identity profile. The DIPS 103 uses its own encryption technique to access the DIP properties for local authentication, and uses the different public keys of the token generator 109 to allow the token generator 109 to later retrieve the encrypted properties for token generation. FIG. 1 illustrates multiple key pairs for the token generator 109 to represent a key pair for each digital identity profile (“DIP”) property. Thus, the HSM 127 will create four different key pairs for the token generator 109, of which the public keys will have been exchanged with the DIPS 103 during the initial key exchange. The DIPS 103 and the token generator 109 will maintain maps of the public keys to the DIP properties. FIG. 1 depicts 4 different locks on a DIP 129 stored in the HSM 127 to represent each property being encrypted with a different public key of the token generator 109 when stored in the HSM 127. FIG. 1 also depicts a digital certificate of the DIPS 103 in the HSM 127. The DIPS 103 provides the digital certificate to the HSM 127 when storing the encrypted DIP properties to associate the DIPS 103 with the stored DIP 129. Without the digital certificate from the DIPS 103, the HSM 127 can reject the request to store the DIP properties, thus preventing a malicious user from storing a DIP that does not originate from the DIPS 103 into the HSM 127.

When an application 113 is installed on the device 101 or is launched on the device 101, the application 113 acts as a CA and conducts a PKI key exchange with the DIPS 103 and the token generator 109. This assumes that the application 113 would participate in the secure identity framework. Some applications may not use authentication and not necessarily participate. Since the application 113 is a participant application, the application 113 self-certifies and certifies the DIPS 103 and the token generator 109.

After the key exchange by the application 113, the application 113 invokes a function call defined by a SAPI of the DIPS 103 to obtain an identity token. This request is communicated to the DIPS 103 but carried out by the token generator 109 pending approval by the DIPS 103. The DIPS 103 will authenticate a user against the biometric elements of the DIP 129. The DIPS 103 will capture a fingerprint and DNA scan, for example, and compare against the appropriate biometric elements of the USER IS property after decryption from the HSM 127. If authentication is successful, then the DIPS 103 notifies the application 113 that the authentication was successful and notifies the token generator 109 that the token generator 109 can generate an identity token (“iToken”) for the application 113.

After obtaining approval, the token generator 109 retrieves the USER IS property from the HSM 127 and decrypts the data with the appropriate private key of the token generator's private keys 110. After generating the iToken, the token generator 109 encrypts the iToken with an appropriate one of the application's public keys 132. The token generator 109 stores the encrypted iToken in the HSM 127 and communicates the encrypted iToken to the application 113. The application 113 can further request one or more privacy tokens (“pToken”) and one or more access tokens (“xToken”). After validating the digital certificates accompanying the requests/invocations, the token generator 109 generates the appropriate tokens with corresponding information from the DIP 129 and communicates and stores the pToken(s) and xToken(s) as it did with the iToken. FIG. 1 depicts in the HSM 127 an encrypted iToken 131, an encrypted iToken_n 140, an encrypted pToken 133, an encrypted pToken_n 141, an encrypted xToken 151, and an encrypted xToken_n 152. The myriad of encrypted tokens illustrates a possible state of the HSM 127 having stored therein multiple application specific token sets. The application 113 decrypts the received tokens with the appropriate ones of its private keys 134 and can then use them for downstream authentication and authorization via a network interface 135.

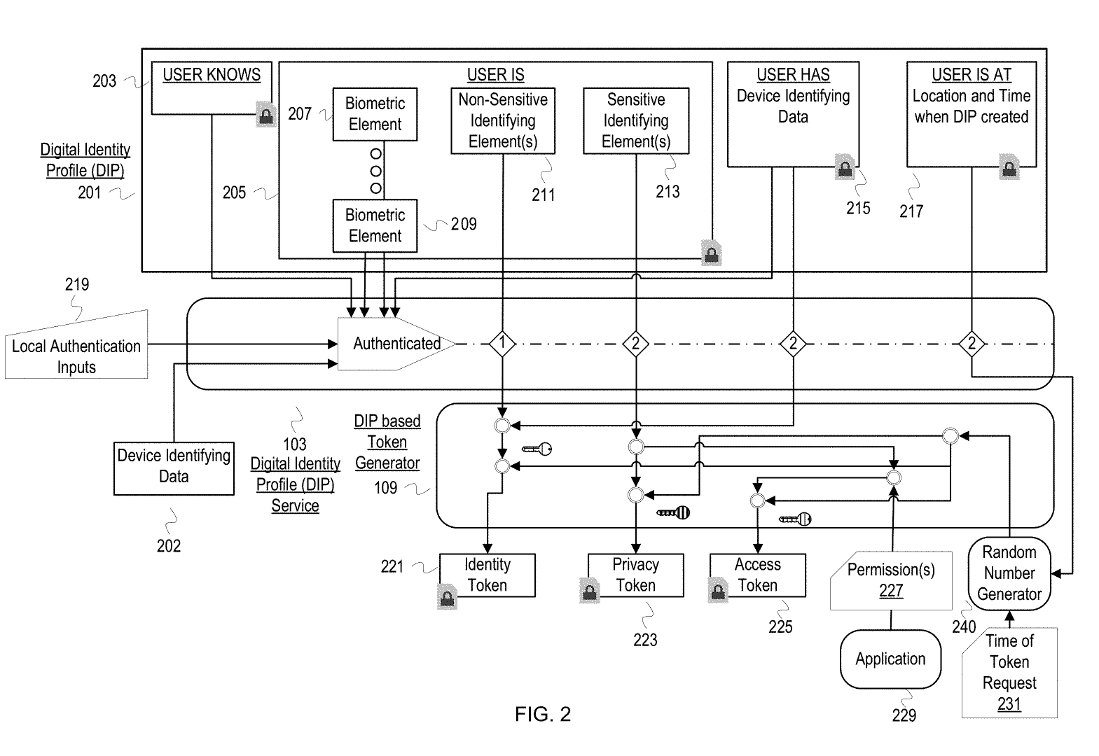

FIG. 2 depicts a token generator generating the various tokens for an application on a device with the secure identity framework. FIG. 2 illustrates a digital identity profile (DIP) 201 comprising properties USER KNOWS 203, USER IS 205, USER HAS 215, and USER IS AT 217, all of which are individually encrypted. The USER IS property 205 includes biometric elements 207, 209. The USER IS property 205 also includes one or more non-sensitive identifying elements 211 and one or more sensitive identifying elements 213. The USER KNOWS property 203 can be locally stored information presumably known only to the user, a CAPTCHA/re-CAPTCH, etc. As previously stated, the USER KNOWS property may be a call to an external KBA service. The USER HAS property 215 include device identifying data, which can be an aggregate of data for a host device. The USER IS AT property 217 includes location and time information when the DIP was created.

When an application participates in the secure identity framework, it begins with triggering the DIPS 103 to locally authenticate a user against the biometric elements 207, 209 and authenticates against the USER HAS property 215. DIPS 103 may also require authentication with a data verification service against the USER KNOWS property 203. The DIPS 103 may be triggered to authenticate when an application 229 is installed or launched. The DIPS 103 authenticates local authentication inputs 219 against the biometric elements 207, 209. The DIPS 103 authenticates device identifying data 202 against the device identifying data of the USER HAS property 215. If successfully authenticated, the DIPS 103 allows the token generator 109 to generate tokens. The depicted diamonds represent this gatekeeper type function of the DIPS 103. The numbers inside of the diamonds indicate that the iToken is generated first and then the other tokens are generated subsequently based on requests from the application 229.

After successful authentication by the DIPS 103, the token generator 109 is permitted to generate an iToken 221 for the application 229. The token generator 109 can retrieve and decrypt the USER IS property to obtain the non-sensitive identifying element(s) to generate the iToken 221. The token generator 109 computes a hash of the non-sensitive information of the non-sensitive identifying elements 211 that will be used to generate the iToken 221 (e.g., first name and last name). The token generator 109 then generates the iToken 221 with the non-sensitive identifying information and the computed hash.

The token generator 109 encrypts the iToken with a public key of the application 229. But the public key is based on the time information of the USER IS AT property of the DIP. The token generator 109 computes a difference between the USER IS AT time information and a time of token request 231, which is when the application 229 requested the iToken from the DIPS 103. This difference value is used as a seed for a random number generator 240, which may be part of a hardware security module or incorporated into the token generator 109. Each token will be associated with a different time of token request, so each token will be encrypted with a different key pair for the application 229. The time value of the USER IS AT property of the DIP can be stored in the order of nanoseconds with a time reference. For instance, the time reference can be the 19th of May 1976 0730 AM Indian Standard Time (IST). The reference time chosen is referred to herein as the Digital Identity Reference Time (DIRT). The USER IS AT time value can be converted to a number of nanoseconds that have elapsed since DIRT and will be referred as the Identity Time Profile Reference (ITPR). The DIRT and ITPR values are used to calculate a seed for the random number generator used in generating the keys that will be used to encrypt the tokens for an application. This seed is referred to herein as the Time Seed Value (TSV) of the random number generator. The TSV can be derived by subtracting ITPR from the time stamp of the token request (“Time of Token Request (TOTR)”) for a particular application as expressed in equation 1.

TSV=TOTR−ITPR (all in nanoseconds) (equation 1).

Due to the already established closed PKI by the application 229, the application can trust the DIPS 103 to obtain at least 3 key pairs for the application 229. The DIPS 103 obtains for the application 229 at least 3 key pairs based on the USER IS AT time value and the time of token request 231 from the application 229. Since the DIPS 103 has access to the time value of the USER IS AT property 217, the DIPS 103 can interact with the HSM to generate the keys for the application 229. The DIPS 103 also incorporates the location information corresponding to the session/transaction of the application 229 (i.e., location of the host device corresponding to the TOTR). The application 229 or the DIPS 103 can be configured to request/obtain n key pairs, with n being greater than 3 to allow the application 229 to have additional keys for additional tokens. The keys are provided to the application 229 from the DIPS 103, and then the application 229 will provide the public keys to the token generator 109 for encrypting tokens. Since multiple keys are provided from the application 229, information is maintained to correlate keys to appropriate ones of the tokens. The token generator 109 can maintain a data structure that to track or map which keys to use for which tokens. The digital certificate of the application 229 can include indications of which keys to use for which tokens. If the key to token mapping is indicated in the application's digital certificate, then the application can rotate and/or refresh keys without burdening the token generator 109 with maintaining this information.

After generation of the iToken 221 and based on invocations/requests by the application 229, the token generator 109 generates a pToken 223 and an xToken 225. The token generator 109 generates the pToken 223 with a sensitive identifying element 213 (e.g., social security number). For the pToken 223, the token generator 109 computes a hash of the sensitive identifying element 213 and creates the pToken 223 with the computed hash. Since the information is sensitive, the pToken 223 does not carry the cleartext version of the sensitive information. An application can request multiple pTokens. In that case, the token generator 109 creates a different pToken for each sensitive identifying element. The token generator 109 does not create a pToken with information for multiple pieces of sensitive identifying information. The token generator 109 generates the pTokens with mutually exclusive sensitive information. If multiple pTokens are generated, then the token generator 109 can use a different application key to encrypt each pToken, if available.

The token generator 109 can generate the xToken 225 proximate with generation of the pToken 223 or based on a separate invocation by the application 229. The token generator 109 generates the xToken 225 based on a set of one or more permissions 227 indicated by the application 229. The token generator 109 computes a hash of the permission set 227 and the pToken or the sensitive identifying element used for the pToken to bind the permission set to the sensitive identifying element of the pToken. The token generator 109 then creates the pToken with the set of permissions and the computed hash. Embodiments can bind an xToken to the non-sensitive identifying information and/or iToken instead of or in addition to the sensitive identifying information.

The xToken 225 may evolve as the application 229 grants more permission since the initial permission set 227 will likely be an initial minimum permission set. As additional permissions are added (or based on removal of a permission), the token generator 109 will compute a hash with the new permission set and generate a new version of the xToken 225. In some cases, the token generator 109 can generate additional xTokens to reflect changes to the permission set. The downstream authorization process can determine the appropriate permissions based on the aggregate of permissions indicated across the multiple xTokens. The token generator 109 can also indicate an expiration date in each of the tokens. The token generator 109 can be programmed to define the expiration date with variation across tokens or limited to particular ones of the tokens (e.g., xTokens). As with the token to key mapping/correspondence, an application's digital certificate can indicate an expiration date or time to live for the keys as a group or individually. Tokens may expire as a consequence of the corresponding keys expiring. In other words, a token may not explicitly expire but expiration of a key pair can prevent decrypting of a token.

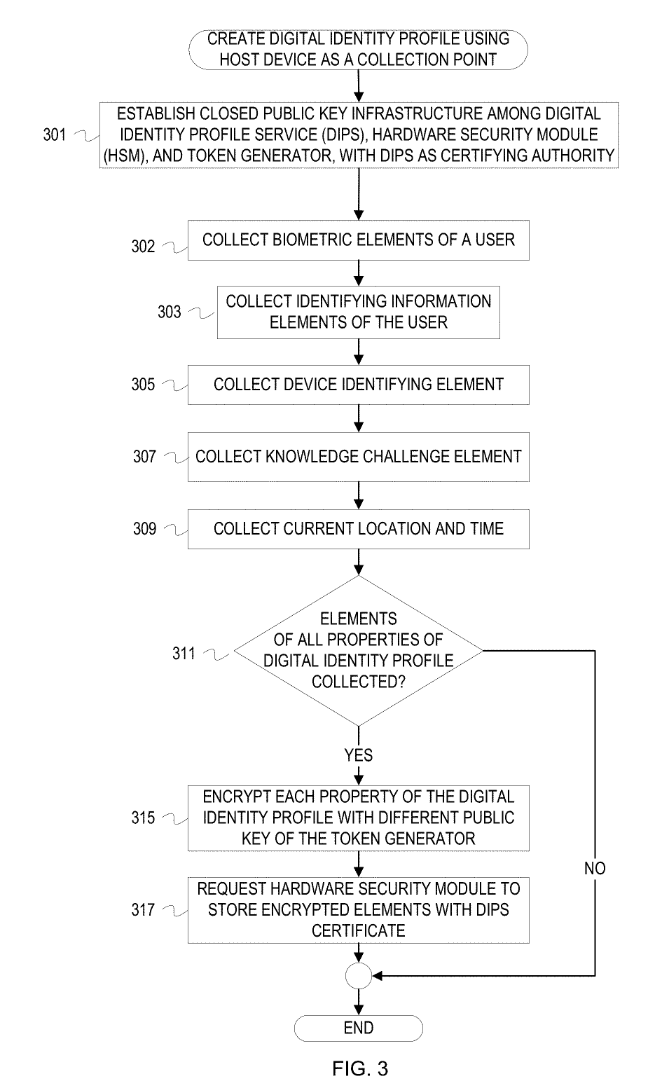

FIG. 3 is a flowchart of example operations for creating a digital identity profile using a host device as a collection point. The description of FIG. 3 refers to the DIPS as performing the operations. The operations are example operations for collecting data for the various properties of a DIP and securely storing the collected data for secure exchange among components of a secure identity framework.

A DIPS will establish a closed PKI among the DIPS, an HSM of the host device, and a token generator (301). The DIPS acts as the certifying authority for the closed PKI. The DIPS can generate the keys used in the key exchange for establishing the closed PKI or interact with the HSM to obtain keys.

After the closed PKI is established, the DIPS can begin collecting data for the DIP. The DIPS begins with collecting the elements of the USER IS property of the DIP. The DIPS collects biometric elements of a user of the host device (302). The DIPS can use the already mentioned input components for capturing multiple biometric elements—facial imagery, fingerprints, ocular identification information, DNA information, etc. The DIPS then collects identifying information elements of the user (303). This information is likely a mixture of sensitive and non-sensitive information. In some embodiments, the DIPS can wait to collect sensitive information until requested by a participant application. The DIPS at least prompts the user to enter basic identifying information, for example name, residential address, phone number, e-mail address, etc. The DIPS can be programmed to request a minimum information set, such as name and e-mail address. The DIPS then collects a device identifying element of the USER HAS property (305). As previously stated, this can be a single host machine identifier or combination of information about the host device. The DIPS can collect host device identifying data for the USER HAS property without user prompting or dependent upon prompting a user as to whether the device can be trusted. The DIPS then collects the knowledge element of the USER KNOWS property (307). This is not necessarily information that the DIPS collects and stores. The DIPS may collect the knowledge element to authenticate the user as an actual human before accepting the collected data. The DIPS can start with a KBA challenge before collecting any other information. After collecting all of the other property data or values, the DIPS collects data for the USER IS AT property (309). The DIPS determines a current location of the host device corresponding to collection of the other DIP property data. This is determined with a geolocation component(s) of the host device. The DIPS also collects a time when the host device is at the determined location. As previously mentioned, the DIPS can obtain other information corresponding to the location, such as altitude and temperature.

If the DIPS has collected the information for all of the DIP properties (311), then the DIPS can proceed with securely storing the collected data of the DIP properties. Otherwise, the collection process terminates. If complete, the DIPS encrypts the collected data for each property of the DIP with a different public key of the token generator (315). The different public keys were obtained during the key exchange (301). Since there are four DIP properties, the DIPS will have collected four public keys from the token generator, unless the USER KNOWS property does not correspond to knowledge that endures (e.g., re-CAPTCHA). The DIPS encrypts the property data with the token generator's public keys to allow the token generator to retrieve and generate tokens when appropriate. Since the DIPS performs local authentication against biometric elements of a DIP, the DIPS also securely stores the DIP for retrieval by the DIPS. In other words, the DIPS stores at least 2 encrypted versions of the DIP. But the DIPS can separately encrypt DIP for the local authentication without a PKI based key set.

The DIPS then requests the HSM to store the encrypted elements of the DIP with the DIPS certificate (317). The DIPS associates its digital certificate with the request(s) to the HSM to allow the HSM to validate identity of the requestor as the DIPS based on the previously established closed PKI. This can be used to prevent an intruder from storing another DIP in the HSM.

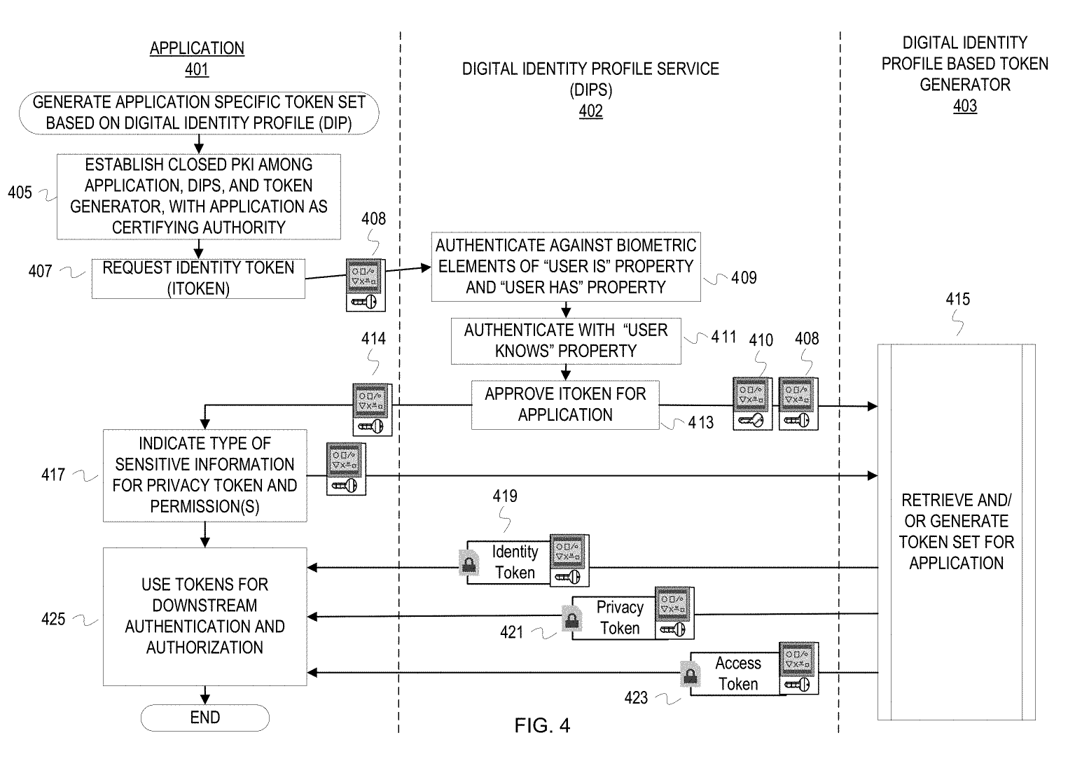

FIG. 4 is a flowchart of example operations for generating an application specific token set based on a digital identity profile (DIP) within a secure identity framework of a host device. FIG. 4 illustrates the interaction among an application 401 that participates in the secure identity framework, a digital identity profile service 402, and a DIP based token generator 403. The host device hosts the application 401, the DIPS 402, and the token generator 403.

When the application 401 is installed on the host device or launches, the application 401 establishes a closed PKI among the application 401, the DIPS 402, and the token generator 403 (405). The application 401 acts as the CA for the closed PKI and certifies the other members of the closed PKI, including itself.

After establishing the closed PKI, the application 401 requests an iToken (407). To request the iToken, the application 401 invokes a function or method defined by a secure API of the DIPS 402. The invocation requires communication of a digital certificate of the application 401 to allow the DIPS 402 to validate the identity of the requestor as the application 401. As part of the invocation, the application 401 indicates a digital certificate 408 that identifies the application 401. A timestamp of this invocation or request will be used for the generation of the application keys to encrypt the tokens.

Based on the iToken request from the application 401, the DIPS 402 authenticates a user against the biometric elements of the USER IS property and against the USER HAS property(409). The DIPS 402 authenticates with at least a fingerprint(s) and DNA scan. The DIPS 402 can authenticate against additional of the biometric elements. The DIPS also obtains identifying information of the host device to determine whether it matches the device identifying information of the USER HAS property to ensure the application and the DIPS are running the correct device for the DIP. If authentication of the biometric elements and USER HAS is successful, then the DIPS 402 may authenticate against the USER KNOWS property (411). The DIPS 402 does not necessarily authenticate with the USER KNOWS property for every iToken request. The DIPS 402 can intermittently or periodically authenticate against the USER KNOWS property. If local authentication is unsuccessful, the process is terminated. If local authentication is successful, then the DIPS 402 notifies the application 401 and the token generator 403 that iToken generation/retrieval is approved (413). The notification to the application 401 is with invocation of a function call defined by the SAPI of the application 401 while the notification to the token generator is with a function call defined by the SAPI of the token generator 403. The DIPS 402 indicates a digital certificate 414 to the application 401 with the notification. The digital certificate 414 was generated by the application 401 for the DIPS 402 when the closed PKI was established by the application 401. The DIPS 402 indicates a digital certificate 410 when notifying the token generator 403 of the iToken approval. This certificate 410 is a self-identifying certificate from the closed PKI previously established by the DIPS 402. The approval notification to the token generator 403 also identifies the application 401 to guide the token generator 403 in generating/retrieving the token set for the appropriate application and to inform the token generator 403 of the proper recipient application for the token set. The DIPS 402 can use the digital certificate 408 to identify the application 401 as the appropriate application recipient.

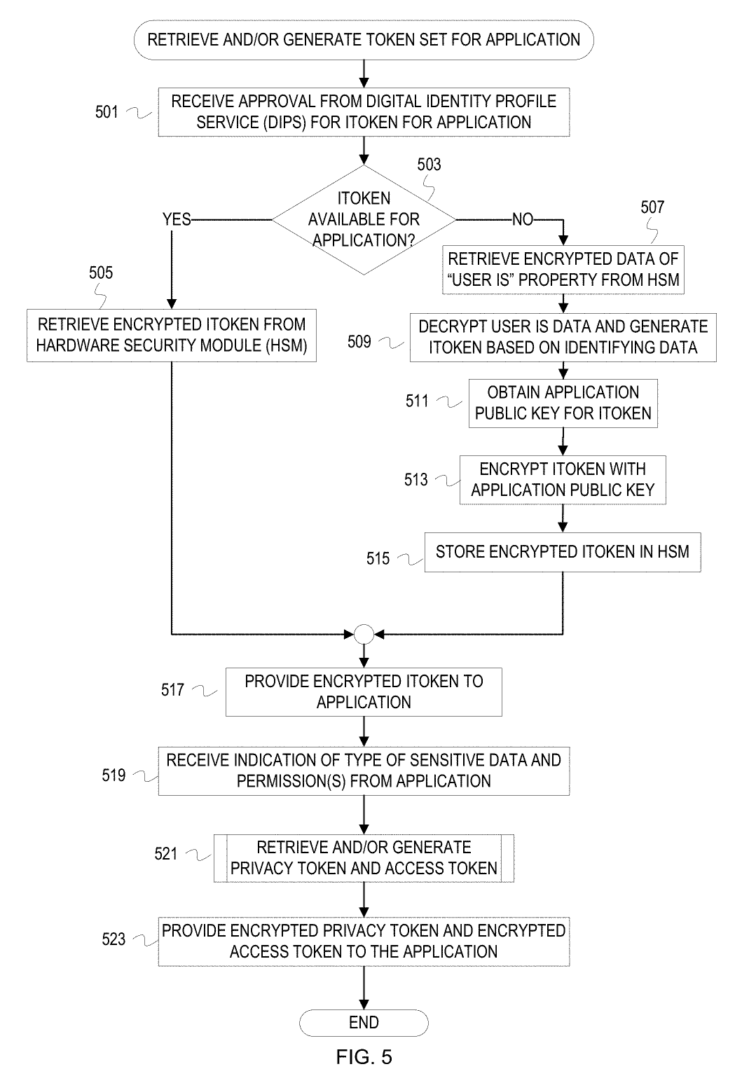

After approval for the iToken, the token generator 403 retrieves and/or generates tokens of the application specific token set and provides the tokens to the application 401 (415). The token generator 403 will provide an iToken 419, a pToken 421, and an xToken 423 to the application 401. FIG. 5 will provide more example details about generating and/or retrieving tokens of an application specific token set. For the pToken and xToken, the application 401 indicates to the token generator (403) the type of sensitive information for the privacy token and a permission set for the access token (417). As depicted in FIG. 4, interactions between the application 401 are done by invocations of SAPI defined functions and indication of digital certificates from the closed PKI established by the application 401. The application 401 uses the application specific token set for downstream authentication and authorization (425). For example, a server process(es) associated with the application 401 will use the token set for authentication and authorization.

FIG. 5 is a flowchart of example operations for retrieving and/or generating a token set for an application. The operations of FIG. 5 refer to a token generator as performing the operations. The depicted set of operations is an example of a token generator accessing data secured by a DIPS to generate tokens for an application and/or retrieving already generated tokens for an application.

A token generator can begin token generation/retrieval after receiving approval from the DIPS of a host system (501). This approval is for the iToken and the approval identifies the requesting application. The approval also indicates location and time information corresponding to the time of request by the identified application. In the above description, all tokens were encrypted with keys of a requesting application. However, embodiments can encrypt the iToken with the token generator public key corresponding to the closed PKI established by the DIPS because the iToken can be common across applications. For instance, numerous applications may have a minimal requirement of first and last name and an iToken can by default be created with that minimum about of user identifying information. If an application requires other identifying information, such as phone number or e-mail address, then the token generator can generate a new iToken or modify an already available iToken to include this additional information. Embodiments may allow for the token generator to generate different iTokens with the varying types of identifying information and maintain a map of which iTokens have been generated for particular identifying elements of the USER IS property.

After receiving the approval, the token generator determines whether an iToken is available for the application (503). If an iToken is available, then the token generator retrieves the encrypted iToken from the HSM (505). The token generator can maintain a data structure that indicates iTokens that have been generated, expiration date, and corresponding application. Alternatively, the HSM can maintain this information for tokens stored by the HSM. In this case, the token generator can invoke a function call defined by a SAPI of the HSM that requires an application identifier and a token type to which the HSM will respond.

If an iToken is not available, then the token generator retrieves encrypted data of the USER IS property from the HSM (507). The token generator will invoke a function defined by the HSM SAPI to retrieve the USER IS data. The token generator decrypts the retrieved USER IS data with the token generator's private key and generates the iToken based on at least a subset of the identifying information of the USER IS data (509). The HSM SAPI can define different function calls for the different elements of the USER IS property so that access to the biometric elements is limited to the DIPS.

After generating the iToken, the token generator encrypts and stores the encrypted iToken. To encrypt the iToken, the token generator obtains an application public key that was generated for encrypting the iToken (511). Since the keys for encrypting tokens use the TOTR, these keys are not generated as part of the application establishing the closed PKI. The token generator can interact with the application and the HSM to obtain the keys for encrypting the tokens or the DIPS can convey the application's keys to the token generator coincident with iToken approval. In an embodiment in which the token generator interacts with the application to obtain the keys, the token generator can retrieve the time value of the USER IS AT property, decrypt it, and include it and the TOTR in a request for the HSM to generate key pairs for the application. The HSM provides the key pairs to the application, and the application provides the public keys to the token generator. The conveyance of the public keys includes the application's digital certificate which directs the token generator as to which key to use to encrypt the iToken. The process can be done on an individual token basis instead of for the group of keys. With the public key of the application, the token generator encrypts the iToken (513). The token generator invokes a function defined by the HSM SAPI to store the encrypted iToken (515). After retrieval (505) or generation (509) of the iToken, the token generator invokes a function defined by the application's SAPI to provide the encrypted iToken to the application (517).

After receipt of the iToken or after approval from the DIPS for the iToken, the application will indicate to the token generator a set of one or more permissions (e.g., account creation, POST actions, etc.) (519). If the application uses sensitive information for authentication, the application will also indicate the type of sensitive data to be used by the application (519). The token generator will retrieve and/or generate corresponding access and privacy tokens for the application based on the indications (521). The token generator then provides the encrypted xToken(s) and pToken(s) to the application (523).

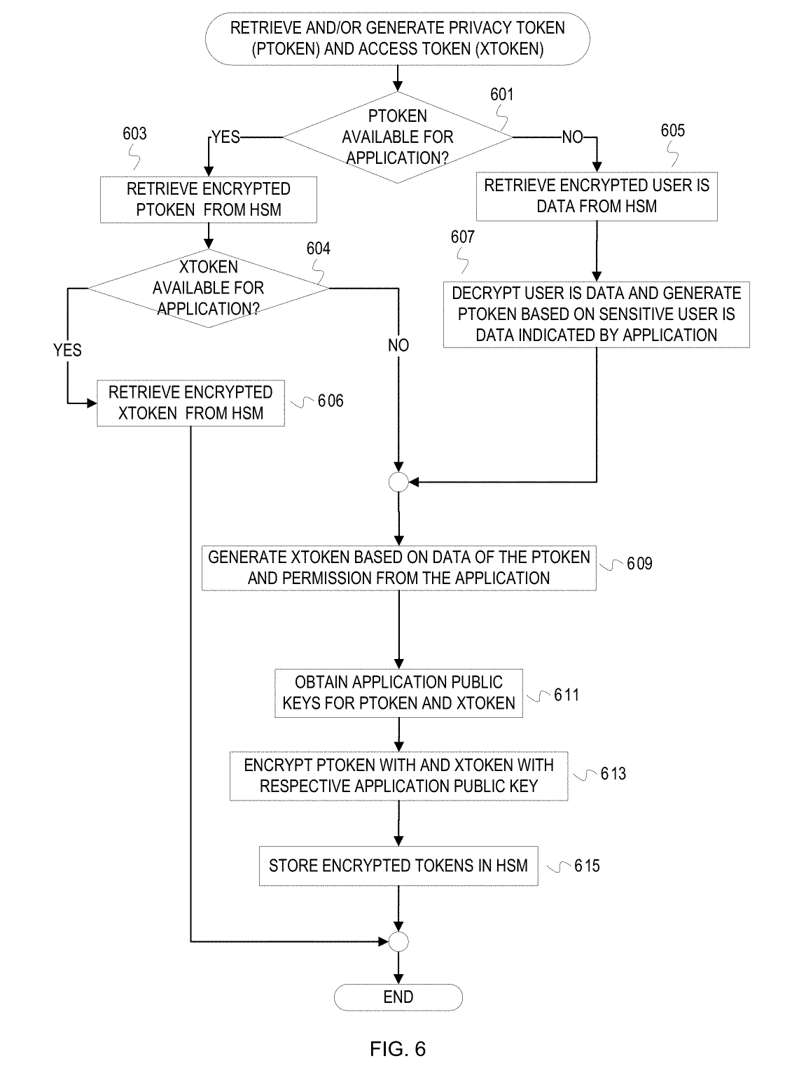

FIG. 6 is a flowchart of example operations to retrieve and/or generate privacy and access tokens for an application. The example operations correspond to block 521 of FIG. 5. FIG. 6 refers to the token generator as performing the example operations.

The token generator determines whether a pToken corresponding to the indicated sensitive information as requested by the application is available in the HSM for the requesting application (601). The pToken and the xToken may be unexpired and the permission set may not have changed. If either token is unexpired, then it will be available in encrypted form in the HSM. If the pToken is available, the token generator retrieves an encrypted pToken from the HSM (603). If multiple pTokens are available and requested by the application, then the token generator retrieves the multiple, available pTokens based on the application request. If a pToken is available that satisfies the application request, then the token generator determines whether an xToken is available that satisfies the application request (604). If so, then the token generator retrieves the available encrypted xToken from the HSM (606). If both tokens were available, then the token generator provides the retrieved, encrypted tokens to the application (523).

If the pToken was not available, then the token generator retrieves the encrypted USER IS data from the HSM (605), assuming that data is not still available in decrypted form to the token generator from the iToken generation. The token generator decrypts the USER IS data and generates a pToken with a value of the type of sensitive data indicated by the application (607). This can be determined with tags or fields defined in the USER IS property. For example, the DIPS can create each property as a distinct data structure with tags or fields to distinguish the different elements/types of information therein. With the retrieved or generated pToken, the token generator then generates the xToken (609). Since the xToken is derived/bound to the pToken, a new xToken is generated if the pToken is expired or unavailable. As mentioned earlier, embodiments may derive/bind the xToken to the iToken instead of the pToken, or to both the pToken and the xToken. In some cases, the xToken may be bound to multiple pTokens.

The token generator then obtains the application public keys for the generated pToken and xToken (611). As previously described, the token generator obtains a different public key for each of the tokens. With the application public key for the pToken, the token generator encrypts the pToken (613). With the application public key for the xToken, the token generator encrypts the xToken (615). The token generator then stores the encrypted tokens in the HSM (615).

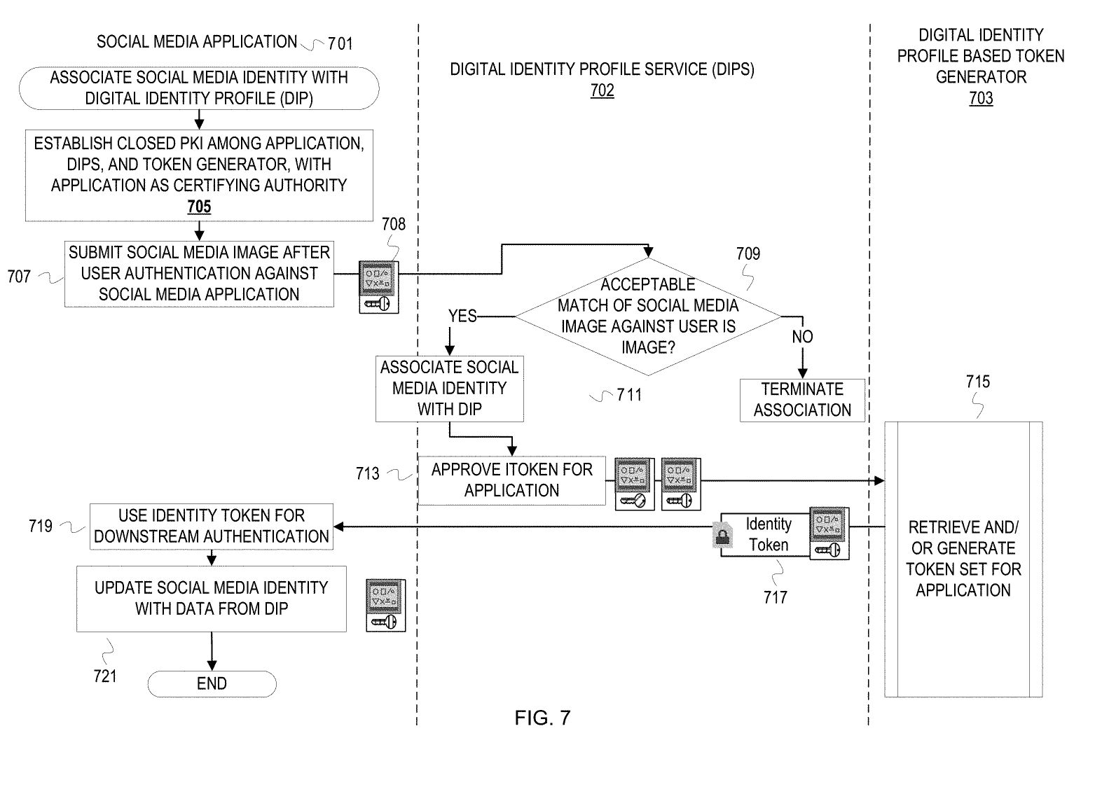

While many types of applications can participate in the secure identity framework on a host device, associating a social media identity of a social media application with the DIP expands the possible use cases of the secure identity framework. The DIP can be augmented with information from the social media identity. FIG. 7 is a flowchart of example operations for associating a social media entity with a digital identity profile. The example operations depicted in FIG. 7 are similar to those of FIG. 4.

When a social media application 701 is installed on a host device or launches on the host device, the social media application 701 establishes a closed PKI among the social media application 701, a DIPS 702, and a DIP based token generator 703 (705). The social media application 701 acts as the CA for the closed PKI and certifies the other members of the closed PKI, including itself.

After establishing the closed PKI, the social media application 701 submits a social media image of a social media identity to the DIPS 702 (707). The submission of the social media image is contingent upon multiple successful authentications. Assuming a legacy social media application, a user logs into a social media account with the social media application. If that is successful, then imagery of the social media identity will be available. The user must also succeed with local authentication by the DIPS (i.e., against the DIP biometric elements, the USER HAS property, etc.) based on launch or install of the social media application 701. A certificate 708 that identifies the social media application 701 accompanies the image submission. This ensures that the image is from the social media application 701 that established the closed PKI with the components of the secure identity framework on the host device. As with the other interactions, the social media application 701 invokes a function defined by a SAPI of the DIPS 702 for submitting an image of a social media identity. The DIPS 702 determines whether the submitted social media identity image satisfies threshold for matching facial imagery of the USER IS property (709). The acceptable threshold can be a configuration of the DIPS or a setting in facial recognition program code used by the DIPS 702. If the match is not acceptable, then the association process is terminated by the DIPS 702. If the match is acceptable, then the DIPS 702 associates the social media identity with the DIP (711). This associating of the social media identity with the DIP of the host device involves programmatically adjusting settings of the social media application 701 to allow the social media application to update data of the social media identity with data of the DIP.

After or concurrent with the association of the social media identity with the DIP, the DIPS 702 notifies the token generator 703 that iToken generation/retrieval is approved (713). The DIPS 702 may also notify the social media application 701 as in FIG. 4.

After approval for the iToken, the token generator 703 retrieves and/or generates tokens and provides the tokens to the social media application 701 (715). The token generator 703 will provide an iToken 717 to the social media application 701. FIG. 5 provides example details about generating and/or retrieving tokens of an application specific token set. The social media application 701 uses the provided iToken 717 for downstream authentication. With the iToken 717, the social media application obtains data from the DIP of the host device to update the social media identity. For instance, the social media application 701 can determine data fields of the social media identity and indicate these to the DIPS 702. The DIPS can then provide data corresponding to the indicated data fields. The DIPS can be configured to filter or block conveyance of certain information, such as sensitive information, to the social media application 701.

Variations and Use Cases

The above examples use images from a social media identity to associate the social media identity with a DIP. However, a social media identity may not have facial imagery or acceptable facial imagery. The DIPS can be configured to allow for association based on other identifying information, such as First Name, Last Name, Mailing Address, and e-mail address. The DIP association with a social media identity can be leveraged for assisting in public safety.

In addition to DIP creation, the DIPS maintains the DIP and re-verifies against the DIP. Maintaining the DIP can involve periodic refresh of various or all elements and updating information. In addition, the DIPS can verify biometric information of against available government authorized biometric and identity databases. This can be used to help with identity correlation and establishment.

A computer application can be written that can consume an iToken, pToken and/or xToken and generate verifiable, and possibly time bound, machine-readable data representation (e.g., 1-dimensional barcode, 2-dimensional bar code, etc.). This will facilitate secure transactions with devices and computing systems that consume digital bar codes.

In addition to the already described use of cryptographic keys in multiple closed PKIs, additional security can be applied to protect the DIP and the tokens. Cryptographic camouflage can be used to achieve a computationally secure state for encryption keys irrespective of their mode of generation. The secure identity framework can use Quantum Key Distribution (QKD) and Forward Secrecy (FS) to protect encryption keys. One Time Pad (OTP) can be used for encrypting a pToken.

Moreover, side channel attacks on a host device and/or HSM can't be ignored. Physically direct and indirect measurable parameters, such as power, heat, radiation and acoustics of the host device can be compensated by selecting and implementing careful randomization. A side channel attack based on observing a processor of the host device can be mitigated using the combination of truly randomized time cycles and camouflaging the output into the channel(s) used for observation.

In some cases, a bearer of a host device and/or the host device itself are subject to distress, fraud, or theft. For these cases, mechanisms can be implemented that lock, disable, and/or delete a DIP, which prevents the generation of any token. The mechanism can be activated by a privileged user's authorized action either performed locally on the device or remotely. The mechanism can be activated with any one or combination of key strokes, touch-swipe-tap gestures, visual gestures such as winks and rolls, customized pre-programmed audio commands, device knock, spin and spatial orientation on a same host device and/or associated device. The token generator can be coupled with an embedded non-re-programmable Write Once Read Many (WORM) micro-chip, herein referred to as a Secure Micro-chip (SMC) that can receive a DIP lock, disable, and/or delete signal via wired and wireless connection. The signal is a broadcast of encrypted unique device identifying data that can be decrypted by the SMC of host device. If the SMC is physically removed, it sends the signal to the HSM for deleting the DIP. The SMC cannot be reused with the same or different host device.

The secure identity framework facilitates authentication without user stores, identity service providers, authentication servers, or a security token service and the accompanying vulnerabilities thereof. An identity provider need not be used, but can supplement the secure identity framework. No user stores are used since the collection point device securely maintains the data for authenticating a user. This avoids the vulnerabilities of having various user stores across various service providers. Likewise, no centralized authentication server is used since a client-server type of authentication is avoided.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 305 can be performed in parallel with the operation of block 302 or prior to the operation of block 302. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for a self-sufficient secure identity framework as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
authenticating a user and a device against biometric elements of a digital identity profile and device identifying information of the digital identity profile, wherein biometric inputs captured by the device at least include a deoxyribonucleic acid (DNA) scan and a fingerprint scan and wherein the digital identity profile is locally secured on the device;
a first process approving an identity token for a requesting application based on successfully authenticating the user and the device;
a second process retrieving encrypted user identifying data of the digital identity profile based on the first process approving the identity token for the requesting application, wherein the device hosts the first process, the second process, and the requesting application;
the second process decrypting the encrypted user identifying data with a first private key of the second process that corresponds to a first closed public key infrastructure key exchange by the first process as a certifying authority;
the second process generating the identity token based, at least in part, on the user identifying data and encrypting the identity token with a first public key of the requesting application that corresponds to a second closed public key infrastructure key exchange by the requesting application as a certifying authority; and
the second process providing the encrypted identity token to the requesting application for downstream authentication.

2. The method of claim 1, wherein the biometric elements further comprise at least one of ocular identifying information and facial imagery.

3. The method of claim 1 further comprising the first process conducting the first closed public key infrastructure key exchange as the certifying authority for the first process, the second process, and a hardware security module of the device.

4. The method of claim 3 further comprising:
after the first closed public key infrastructure key exchange,
collecting the biometric elements and the user identifying data as a first property of the digital identity profile;
collecting the device identifying information as a second property of the digital identity profile;
collecting location data of the device and time data corresponding to the location data as a third property of the digital identity profile;
separately encrypting each property of the digital identity profile for access by the first process; and
securely storing each of the encrypted properties of the digital identity profile on the device.

5. The method of claim 4 further comprising generating keys for the requesting application based, at least in part, on the time data corresponding to the location data and time data corresponding to the requesting application requesting the identity token.

6. The method of claim 4 further comprising associating a digital certificate that identifies the first process with the securely storing of each of the encrypted properties.

7. The method of claim 4 further comprising:
also encrypting each property of the digital identity profile for access by the second process, wherein encrypting each property for access by the second process comprises encrypting each property with a different public key of the second process, wherein the different public keys of the second process correspond to the first closed public key infrastructure key exchange; and
securely storing each of the properties encrypted for access by the second process on the host device.

8. The method of claim 1 further comprising:
the requesting application also requesting a privacy token and an access token from the second process, wherein the requesting comprises indicating a set of one or more permissions for the requesting application and a type of sensitive user identifying data for the privacy token;
the second process generating the privacy token based on sensitive user identifying data of the type indicated by the requesting application, wherein the decrypted user identifying data comprises the sensitive user identifying data and non-sensitive user identifying data that was used for generating the identity token;
the second process encrypting the privacy token with a second public key of the requesting application;
the second process generating the access token based, at least in part, on the set of one or more permissions and at least one of the non-sensitive user identifying data and the sensitive user identifying data;
the second process encrypting the privacy token with a third public key of the requesting application, wherein the second and third public keys also correspond to the second closed public key infrastructure key exchange; and
the second process providing the encrypted tokens to the requesting application for downstream authentication and authorization.

9. The method of claim 8, wherein the requesting application requesting the privacy token and the access token comprises the requesting application also indicating a digital certificate that identifies the requesting application, wherein the digital certificate corresponds to the second closed public key infrastructure key exchange and wherein the digital certificate indicates correspondence between public keys and token types.

10. The method of claim 9, wherein the requesting application requesting the privacy token and the access token comprises the requesting application invoking a function defined by a secure application programming interface of the second process.

11. The method of claim 1, wherein authenticating the user is also based on knowledge based authentication and without an authentication server or identity service provider.

12. The method of claim 1 further comprising the first process determining second location data of the device corresponding to when the requesting application requests the identity token and associating the second location data with the identity token.

13. One or more non-transitory machine-readable media comprising program code for a secure identity framework, the program code comprising:
first program code to,
authenticate a user and a device against biometric elements of a digital identity profile and device identifying information of the digital identity profile, wherein biometric inputs captured by the device at least include a deoxyribonucleic acid (DNA) scan and a fingerprint scan;
approve an identity token for a requesting application based on successful authentication of the user and the device and associate a first digital certificate of the first program code with the approval;
second program code to,
validate an approval for an identity token based on a digital certificate that accompanies the approval,
retrieve encrypted user identifying data of the digital identity profile based on validation of the approval for the identity token for the requesting application;
decrypt the encrypted user identifying data with a first private key of the second program code that corresponds to a first closed public key infrastructure key exchange by an executing instance of the first program code as a certifying authority,
generate the identity token based, at least in part, on the user identifying data and encrypt the identity token with a first public key of the requesting application that corresponds to a second closed public key infrastructure key exchange by the requesting application as a certifying authority, and
provide the encrypted identity token to the requesting application for downstream authentication.

14. The non-transitory machine-readable media of claim 13, wherein the biometric elements further comprise at least one of ocular identifying information and facial imagery.

15. The non-transitory machine-readable media of claim 13, wherein the first program code further comprises program code to conduct the first closed public key infrastructure key exchange as the certifying authority for an instance of the first program code, an instance of the second program code, and a hardware security module of the device.

16. The non-transitory machine-readable media of claim 15 further comprising the first program code to:
after the first closed public key infrastructure key exchange,
collect the biometric elements and the user identifying data as a first property of the digital identity profile;
collect the device identifying information as a second property of the digital identity profile;
collect location data of the device and time data corresponding to the location data as a third property of the digital identity profile;
separately encrypt each property of the digital identity profile for access by an instance of the first program code; and
securely store each of the encrypted properties of the digital identity profile on the device.

17. A apparatus comprising:
a processor;
a lens-less imaging device;
a camera;
one or more geolocation components;
an embedded hardware security module;
a network interface; and
a machine-readable medium having program code executable by the processor to cause the apparatus to,
authenticate with a first process a user and the apparatus against biometric elements of a digital identity profile and device identifying information of the digital identity profile, wherein biometric inputs captured by the lens-less imaging device at least include a deoxyribonucleic acid (DNA) scan and a fingerprint scan and wherein the digital identity profile is locally secured on the hardware security module;
approve with the first process an identity token for a requesting application based on successful authentication of the user and the apparatus;
retrieve with a second process encrypted user identifying data of the digital identity profile based on the first process approving the identity token for the requesting application, wherein the apparatus hosts the first process, the second process, and the requesting application;
decrypt with the second process the encrypted user identifying data with a first private key of the second process that corresponds to a first closed public key infrastructure key exchange by the first process as a certifying authority;
generating with the second process the identity token based, at least in part, on the user identifying data and encrypting the identity token with a first public key of the requesting application that corresponds to a second closed public key infrastructure key exchange by the requesting application as a certifying authority; and
provide from the second process the encrypted identity token to the requesting application for downstream authentication.

18. The apparatus of claim 17, wherein the biometric elements further comprise at least one of ocular identifying information and facial imagery.

19. The apparatus of claim 17 further comprising the program code executable by the processor to cause the apparatus to conducting with the first process as the certifying authority the first closed public key infrastructure key exchange for the first process, the second process, and the hardware security module.

20. The apparatus of claim 19 further comprising a spectrograph, wherein the program code is further executable by the processor to cause the apparatus to:
after the first closed public key infrastructure key exchange,
collect with the first process the biometric elements from the lens-less imaging device, camera, and the spectrograph, and the user identifying data as a first property of the digital identity profile;
collect with the first process the device identifying information as a second property of the digital identity profile;
collect with the first process location data of the apparatus and time data corresponding to the location data as a third property of the digital identity profile;
separately encrypt each property of the digital identity profile for access by the first process; and
securely store each of the encrypted properties of the digital identity profile in the hardware security module.
